(19) United States
(12) Patent Application Publication
(10) Pub. No.: US 2025/0241341 A1
(43) Pub. Date: Jul. 31, 2025

(54) BEVERAGE COMPRISING VITAMIN D OR ITS DERIVATIVES HAVING IMPROVED STABILITY

(71) Applicant: SOCIETE DES PRODUITS NESTLE S.A., Vevey (CH)

(72) Inventors: LAURENT SAGALOWICZ, Blonay (CH); CECILE LAURENT, Girmont (FR); ERIC GABRIEL MARCHAL, Vittel (FR); MARION DECHASEAUX, Vittel (FR); ADRIEN SALLE, Epinal (FR); NAIS FREREJACQUES, Epinal (FR); MARINE LONJOU, Paris (FR)

(21) Appl. No.: 18/855,887

(22) PCT Filed: Apr. 4, 2023
(86) PCT No.: PCT/EP2023/058835

§ 371 Date: Oct. 10, 2024

(30) Foreign Application Priority Data
Apr. 12, 2022 (EP) 22168006.9

(51) Int. Cl. A23L 2/52

(52) U.S. Cl. CPC A23L 2/52

(57) ABSTRACT

The present invention relates to a beverage comprising vitamin D or its derivatives, a hydrocolloid and a triglyceride and to a packaged beverage comprising said beverage. The present invention also relates to a process for obtaining such beverage and to the use thereof.

### FIELD OF THE INVENTION

The present invention relates to a beverage comprising vitamin D or its derivatives, a hydrocolloid and a triglyceride and to a packaged beverage comprising said beverage. The present invention also relates to a process for obtaining such beverage and to the use thereof.

### BACKGROUND AND PRIOR ART

Vitamin D is a micronutrient, having a crucial role in calcium homeostasis, bone metabolism and immunity. Vitamin D may be naturally present in food, added to food and may be also available as a dietary supplement. Vitamin D may also be produced endogenously when ultraviolet (UV) rays from sunlight strike the skin and trigger vitamin D synthesis. Vitamin D mainly exists under two forms, namely vitamin D2 (ergocalciferol), which is synthetized by plants and vitamin D3 (cholecalciferol), which is synthetized in the human skin by an exposure to sunlight (UVB irradiation).

Recent studies highlight the importance of vitamin D in the prevention of cancer, cardiovascular diseases, diabetes, immunological and neurological disorders. In particular, it has been discovered that Vitamin D is involved in immune function and has significant effects on immune cells. Vitamin D also plays a crucial role in calcium and phosphorus metabolism.

Vitamin D deficiency is a global public health issue. Vitamin D insufficiency affects almost 50% of the population worldwide. An estimated 1 billion people worldwide, across all ethnicities and age groups, in both developed and developing countries, have a vitamin D deficiency. The prevalence of patients with vitamin D deficiency is highest in the elderly, obese patients, nursing home residents, and hospitalized patients.

Vitamin D deficiency can lead to a loss of bone density, which can contribute to osteoporosis and fractures (broken bones) but also to other diseases such cardiovascular diseases or cognitive impairments in older adults. In children, symptoms of vitamin D deficiency may be irritability, lethargy, developmental delay, bone changes, and/or fractures.

Guidelines from the National Institute of Health increased the recommended dietary allowance (RDA) of vitamin D to 600 international units (IU) for everyone ages 1-70, and raised it to 800 IU for adults older than age 70 to optimize bone health. The safe upper limit was also raised to 4,000 IU (1 IU of Vitamin D=0,025 μg of Vitamin D) for adults according to the guidelines from the National Institute of Health.

Treatment for vitamin D deficiency involves getting more vitamin D, through dietary and supplements.

Nowadays, there is growing interest in fortifying beverage with Vitamin D to improve human health and wellness. Fortification of a beverage is an effective way to supplement vitamin D. However, during processing and storage, different factors such as pH, light, oxygen and temperature may be responsible of chemical degradation of vitamin D and thus may conduct to a loss of its activity. As a lipophilic compound, its introduction, in particular, in a beverage, such as a fortified beverage, requires the formation of an emulsion. The emulsion has to be stable to prevent its degradation for example due to physical mechanisms, such as coalescence, which may disorganize the emulsion and let vitamin D be subjected to chemical degradation.

However, the lipophilic properties and stability issues of Vitamin D make its introduction in an emulsion a real challenge. Furthermore, vitamin D is lipophilic and needs to be dispersed in water, which may become an issue. The challenge is thus also to preserve the stability of the emulsion in diluted form that is the beverage without adding additional surfactants in water phase, which may be associated with costs and off-flavor issues.

There is thus a need to provide beverage comprising the correct dose of vitamin D (thereby avoiding an excessive amount or a non-significant amount thereof) while being sufficiently stable to ensure that Vitamin D be preserved during processing, storage and/or transportation.

### SUMMARY OF THE INVENTION

A first object of the present invention relates to a beverage comprising:
between 1.10-7% and 8.10-5% by weight, preferably between 1.10-7% and 3,2.10-5% by weight, and more preferably between 1.10-7% and 0,8.10-5% by weight, of vitamin D or its derivatives with respect to the total weight of beverage,
between 0,0005% and 1,2% by weight, preferably between 0.001% and 0.5% by weight, and more preferably between 0,0015% and 0.2% by weight, of hydrocolloid with respect to the total weight of beverage, and
between 0,000003% and 0.2% by weight, preferably between 0,00001% and 0.05% by weight, and more preferably between 0,0001% and 0.01% by weight, of triglyceride with respect to the total weight of beverage.

A second object of the present invention relates to a packaged beverage comprising the beverage as previously defined.

A third object of the present invention relates to a process for preparing the beverage as previously defined comprising:
a step of mixing triglyceride and vitamin D or its derivatives, optionally monoglyceride or its derivatives and optionally oat oil or oat oil fraction rich in polar lipid, thereby providing a fat phase,
a step of dispersing the hydrocolloid in water, thereby providing an hydrocolloid dispersion, and
a step of mixing the fat phase and hydrocolloid dispersion, thereby providing a mixture of fat phase and hydrocolloid dispersion.

A fourth object of the present invention relates to the use of the beverage as previously defined and of the packaged beverage comprising said beverage as previously defined, as a functional beverage.

### DETAILED DESCRIPTION

In the following description and claims, unless otherwise specified, the ranges of values shown are inclusive. The words “comprises”, “comprising”, and similar words, should not be interpreted in an exclusive or exhaustive sense. In other words, they are intended to mean “including, but not limited to”.

A first object of the present invention relates to a beverage comprising:
between 1.10-7% and 8.10-5% by weight, preferably between 1.10-7% and 3,2.10-5% by weight, and more preferably between 1.10-7% and 0,8.10-5% by weight, of vitamin D or its derivatives with respect to the total weight of beverage,
between 0,0005% and 1,2% by weight, preferably between 0.001% and 0.5% by weight, and more preferably between 0,0015% and 0.2% by weight, of hydrocolloid with respect to the total weight of beverage, and
between 0,000003% and 0.2% by weight, preferably between 0,00001% and 0.05% by weight, and more preferably between 0,0001% and 0.01% by weight, of triglyceride with respect to the total weight of beverage.

By “beverage” it is herein preferably understood any liquid suitable for drinking, including for example water, soda, tea, coffee, milk and/or juice. Preferably, the beverage is water.

Preferably, the beverage composition comprises water.

Preferably, the amount of water is comprised between 83,5% and 99,999% by weight, preferably between 92,95% and 99,999% by weight, more preferably between 96% and 99,998% by weight, more preferably between 96,78% and 99,998% by weight, more preferably between 98% and 99,998% by weight, more preferably between 99% and 99,998% by weight, more preferably between 99,2% and 99,998% by weight, more preferably between 99,5% and 99,997% by weight, more preferably between 99,9% and 99,996% by weight and even more preferably between 99,98% and 99,995% by weight with respect to the total weight of the beverage.

By “vitamin D or its derivatives” also referred to as “calciferol”, it is herein preferably understood a group of fat-soluble secosteroids.

Examples of vitamin D include, but are not limited to, vitamin D1, vitamin D2, vitamin D3, vitamin D4, vitamin D5, and mixtures thereof.

Examples of derivatives of vitamin D include, but are not limited to, any vitamin D analogs, such as alfacalcidol, calcitriol, paricalcitol, dihydrotachysterol, and mixtures thereof.

Preferably, the vitamin D is under oil form.

By “triglyceride” it is herein preferably understood an ester formed from glycerol and three fatty acid groups. Triglycerides are the main constituents of most fats and oils.

Advantageously, the triglyceride constitutes the oil phase of the beverage.

Triglyceride is made of three fatty acids having an aliphatic tail of preferably 4-26 carbon atoms, preferably 6-20 carbons.

Source of triglyceride is taken from coconut oil, corn oil, cottonseed oil, olive oil, palm oil, peanut oil, rapeseed oil, safflower oil, sesame oil, soybean oil, sunflower oil, almond oil, Brazil nut oil, cashew nut oil, hazelnut oil, macadamia oil, pecan oil, pine nut oil, pistachio oil, walnut oil, pumpkin seed oil, egusi seed oil, pumpkin seed oil, watermelon seed oil, amaranth oil, apricot oil, apple seed oil, avocado oil, cocoa butter, coriander oil, flaxseed oil, grape seed oil, hemp oil, chia oil, quinoa oil, rice bran oil, wheat bran oil, shea butter, sacha inchi oil, tigernut oil, tomato seed oil, wheat oil and mixture thereof.

Preferably, the triglyceride is a medium chain triglyceride.

By “medium chain triglyceride” or “MCT” it is herein preferably understood triglyceride with three fatty acids having an aliphatic tail of 6-12 carbon atoms, preferably 6-10 carbon atoms and more preferably 8-10 carbon atoms, i.e. a medium-chain fatty acids.

Examples of fatty acids comprise, but are not limited to, caproic fatty acid, caprylic fatty acid, capric fatty acid, lauric fatty acid, and mixtures thereof.

The medium chain triglycerides may be found, for example, in coconut oil, palm kernel oil, palm oil, soybean oil, sunflower oil, rapeseed oil, or mixtures thereof.

By “hydrocolloid” it is herein preferably understood any water-soluble polymers that contribute viscosity of an emulsion or a solution. Examples of hydrocolloid include, but are not limited to, proteins including milk proteins such as caseinate and β-lactoglobulin, egg proteins, gelatin, vegetable-derived protein isolates such as soy and wheat protein isolates, saponins such as saponin from Quillaja saponaria, and polysaccharides.

Preferably, the hydrocolloid is selected from the group consisting of polysaccharides such as acacia gum, xanthan gum, gelatin, carrageenan gum, gellan gum, karaya gum, larch gum, dextran, chitosan, alginate, hyaluronic acid, guar gum, pectin, cellulose, tara gum, tamarind gum, ghatti gum, curdlan gum, konjac glucomannan, scleroglucan, pullulan, agar, tragacanth gum, Portulaca oleracea gum, galactomannan, pectin, starch or modified starch, cellulose derivative such as caboxymethylcellulose, and furcelleran, and mixtures thereof. More preferably, the hydrocolloid is selected from pectin, acacia gum, guar gum, modified starch and mixtures thereof.

By “acacia gum” it is herein preferably understood a gum selected from acacia Senegal gum, acacia Seyal gum, acacia Senegalia laeta gum, acacia Senegalia mellifera gum, acacia Senegalia gourmaensis gum, acacia Sterculia setigera gum, acacia eficacia™ gum, and mixtures thereof.

By “pectin” it is herein preferably understood any pectin such as beet pectin, citrus pectin and/or amidated pectin.

Advantageously, hydrocolloids act as emulsifiers by stabilizing physically the beverage and protecting lipophilic functional compounds, and in particular vitamin D, encapsulated in oil droplets. Thus, these molecules may be capable of adsorbing at the interface oil/water, may form a protective layer around the oil droplets and may prevent the aggregation phenomenon.

The hydrocolloid content may have an impact on the average oil droplet size and thus on beverage stability. In particular, the average oil droplet size may decrease when the content of hydrocolloid increases.

The present inventors have surprisingly found that hydrocolloid and triglyceride enable to physically and chemically stabilize the beverage while protecting Vitamin D during a prolonged period (shelf life).

In particular, the inventors have surprisingly found that when the beverage comprises between 0,000003% and 0.2% by weight of triglyceride with respect to the total weight of beverage, and between 0,0005% and 1,2% by weight of hydrocolloid with respect to the total weight of beverage, the beverage is physically stable, there is no oil droplets aggregation and no creaming, and more important there is no or low chemical degradation of vitamin D such as oxidation, during shelf life.

When the hydrocolloid content is too high, the beverage is too high in calories since most hydrocolloids are polysaccharides and also contain sugar. In the same manner, when the triglyceride content is superior to 0.2% by weight with respect to the total weight of beverage, the beverage is too high in calories.

By contrast, when the hydrocolloid content is inferior to 0,0005% by weight and/or when the triglyceride content is inferior to 0,000003% by weight with respect to the total weight of the beverage, the beverage is not sufficiently stable and vitamin D is not sufficiently protected from degradation. In particular, when the triglyceride content is too low, vitamin D is subjected to chemical degradation and when the hydrocolloid content is too low, the beverage is physically unstable.

The beverage may further comprise between 0,00002% and 0.05% by weight, preferably between 0,00005% and 0.02% by weight, and more preferably between 0,0001% and 0,005% by weight, of oat oil or oat oil fraction rich in polar lipid with respect to the total weight of beverage.

By “oat oil fraction rich in polar lipid”, it is herein preferably understood an oat oil fraction comprising polar lipids.

By “polar lipid”, it is herein preferably understood any amphiphilic lipids with a hydrophilic head and a hydrophobic tail. Examples of polar lipids include, but are not limited to, phospholipids, galactolipids, and mixtures thereof.

Preferably, the oat oil fraction comprising polar lipids is an oat oil fraction comprising phospholipids and/or galactolipids, and more preferably an oat oil fraction comprising more than 10% by weight, preferably more than 25% by weight and more preferably more than 50% by weight of phospholipids and/or galactolipids with respect to the total weight of oat oil fraction.

The beverage may further comprise a monoglyceride or its derivatives.

By “monoglyceride” also referred to as “monoacylglycerol”, it is herein preferably understood compounds composed of a molecule of glycerol linked to a fatty acid via an ester bond.

Preferably, the monoglyceride is composed of a molecule of glycerol linked to a Ce to C20 fatty acid.

The monoglyceride may be found, for example, in olive oil, seed oils such as cottonseed oil, sunflower oil and rapeseed oil.

Preferably, the monoglyceride is unsaturated. More preferably, the monoglyceride is unsaturated and contains less than 30% of saturated fatty acids.

Preferably, the monoglyceride is composed of a molecule of glycerol linked to a fatty acid via an ester bond, preferably of a molecule of glycerol linked to oleic acid or linoleic acid via an ester bond.

Preferably, the fatty acid is composed of more than 50% of oleic acid or linoleic acid.

Derivatives of monoglyceride include, but are not limited to, acetylated monoglycerides (ACETEM), lactylated monoglycerides (LACTEM), diacetyl tartaric acid monoglycerides (DATEM) and citric acid esters of monoglycerides (CITREM).

Advantageously, the monoglycerides or its derivatives may act as emulsifiers and may help to decrease oil droplet size.

Without to be bound by any theory, the present inventors have found that, vitamin D, which is lipophilic but contains an hydroxyl group, may be located in the interface between oil droplets and water where all oxidation reactions may take place and where it is likely that vitamin D may degrade very fast. The present inventors have surprisingly found that the presence of monoglyceride or its derivatives may be able to create a polar structure (reversed micelles) inside the oil droplets, which may enable the vitamin D to be located in the interior of droplets, far from the interface and thus to be more protected from chemical degradation.

The present inventors surprisingly found that the use of monoglyceride was advantageous, whereas monoglyceride is known to destabilize emulsions in some cases, and is prone to oxidation.

The beverage may comprise between 0,00002% and 0.1% by weight, preferably between 0,00005% and 0.02% by weight, and more preferably between 0,0001% and 0,002% by weight, of monoglyceride or its derivatives with respect to the total weight of beverage.

A small content of monoglyceride or its derivatives may be sufficient to help to decrease droplet oil size. By contrast, a high content of monoglyceride or its derivatives may cause problem of processing because of the ability of the monoglyceride or its derivatives to crystallize and to form viscous lyotropic liquid phases.

When the beverage contains monoglyceride or its derivatives, a content of monoglyceride or its derivatives comprised between 0,00002% and 0.1% by weight with respect to the total weight of beverage may help to decrease oil droplets size and therefore may help to provide a stable beverage by decreasing aggregation phenomenon. By contrast, when the beverage contains monoglyceride or its derivatives, a content of monoglyceride or its derivatives superior to 0.1% by weight with respect to the total weight of beverage may cause aggregation phenomenon due to the ability of monoglyceride or its derivatives to crystallize and to form viscous lyotropic liquid phases.

The amount of triglyceride and optionally monoglyceride or its derivatives and/or optionally oat oil or oat oil fraction rich in polar lipid may constitute the lipid content. The present inventors have found that when the beverage comprises triglyceride and optionally monoglyceride or its derivatives and/or optionally oat oil or oat oil fraction rich in polar lipid in the amount as previously disclosed, the beverage as disclosed is stable and vitamin D is protected from degradation.

Preferably, the ratio between the total amount of hydrocolloid and the total amount of vitamin D or its derivatives in the beverage (hydrocolloid/vitamin D) is comprised between 5 and 1 000 000, preferably between 200 and 200 000, more preferably between 1 000 and 100 000, and even more preferably 5 000 and 50 000.

Preferably, the ratio between the total amount of triglyceride and optionally oat oil or oat oil fraction rich in polar lipid and the total amount of vitamin D or its derivatives in the beverage (triglyceride and optionally oat oil or oat oil fraction rich in polar lipid/vitamin D) is comprised between 150 and 100 000, preferably between 500 and 30 000, more preferably between 900 and 10 000, and even more preferably between 1 000 and 5 000.

Preferably, the ratio between the total amount of triglyceride and optionally oat oil or oat oil fraction rich in polar lipid and monoglyceride or its derivatives, and the total amount of vitamin D or its derivatives in the beverage ((triglyceride and optionally oat oil or oat oil fraction rich in polar lipid and monoglyceride or its derivatives)/vitamin D) is comprised between 150 and 100 000, preferably between 500 and 30 000, more preferably between 900 and 10 000, and even more preferably between 1 000 and 5 000.

Preferably, the ratio between the total amount of hydrocolloid and the total amount of triglyceride and optionally oat oil or oat oil fraction rich in polar lipid in the beverage (hydrocolloid/triglyceride and optionally oat oil or oat oil fraction rich in polar lipid) is comprised between 1 and 100, preferably between 2 and 20, and more preferably between 4 and 15.

Preferably, the ratio between the total amount of hydrocolloid and the total amount of triglyceride and optionally oat oil or oat oil fraction rich in polar lipid and monoglyceride or its derivatives in the beverage (hydrocolloid/(triglyceride and optionally oat oil or oat oil fraction rich in polar lipid and monoglyceride or its derivatives)) is comprised between 1 and 100, preferably between 2 and 50, and more preferably between 3 and 10.

Preferably, the ratio between the total amount of triglyceride and optionally oat oil or oat oil fraction rich in polar lipid and the total amount of monoglyceride or its derivatives in the beverage (triglyceride and optionally oat oil or oat oil fraction rich in polar lipid/monoglyceride or its derivatives) is comprised between 0.5 and 100, preferably between 0,8 and 10, and more preferably between 1 and 8.

The present inventors have surprisingly found that the ratios as disclosed enable to obtain a beverage with an optimized average oil droplet size and therefore a stable beverage with low calory intake.

The beverage may further comprise a monosaccharide, a disaccharide, or mixtures thereof.

Examples of monosaccharide and disaccharide include, but are not limited to, fructose, glucose, galactose, sucrose, lactose, maltose, and mixtures thereof.

The monosaccharide and disaccharide may be used to increase density and viscosity of the beverage.

The monosaccharide and/or disaccharide may be present in a concentration ranging from 0% to 15% by weight, preferably from 0.01% to 6,5% by weight and more preferably from 0.1% to 3,5% by weight with respect to the total weight of the beverage.

The beverage may further comprise an acid.

The acid may be selected from the group consisting of citric acid, malic acid, lactic acid, tartaric acid, phosphoric acid, ascorbic acid, and mixtures thereof.

The acid may be present in a concentration ranging from 0% to 2% by weight, preferably from 0.01% to 1% by weight and more preferably from 0.01% to 0.5% by weight with respect to the total weight of the beverage.

The acid as previously defined may act as antioxidant.

The beverage may further comprise an antioxidant other than the acid as previously defined, preferably selected from the group consisting of tocopherol and its derivatives such as DL-α-tocopherol, ascorbic acid and its derivatives such as ascorbic palmitate, synthetic antioxidants such as butylated hydroxytoluene, butyl hydroxyanisole and tertiary butyl hydroquinone, vegetable extracts such as rosemary and green tea, phenolic acids such as caffeic, quinic and chlorogenic acids, caffeine, amino acids, phenyl indanes and sequestering agents such as citrates and ethylenediaminetetraacetic acid (EDTA), and mixtures thereof.

The antioxidant other than the acid may be present in a concentration ranging from 0% to 0,0002% by weight, preferably from 0,000005% to 0,0001% by weight and more preferably from 0,00001% to 0,00005% by weight with respect to the total weight of the beverage.

Preferably, the beverage as defined in the present invention comprises:
between 1.10-7% and 8.10-5% by weight, preferably between 1.10-7% and 3,2.10-5% by weight, and more preferably between 1.10-7% and 0,8.10-5% by weight, of vitamin D or its derivatives with respect to the total weight of beverage,
between 0,0005% and 1,2% by weight, preferably between 0.001% and 0.5% by weight, and more preferably between 0,0015% and 0.2% by weight, of hydrocolloid with respect to the total weight of beverage,
between 0,000003% and 0.2% by weight, preferably between 0,00001% and 0.05% by weight, and more preferably between 0,0001% and 0.01% by weight, of triglyceride with respect to the total weight of beverage,
between 83,5% and 99,999% by weight, preferably between 92,95% and 99,999% by weight, more preferably between 96% and 99,998% by weight, more preferably between 96,78% and 99,998% by weight, more preferably between 98% and 99,998% by weight, more preferably between 99% and 99,998% by weight, more preferably between 99,2% and 99,998% by weight, more preferably between 99,5% and 99,997% by weight, more preferably between 99,9% and 99,996% by weight and even more preferably between 99,98% and 99,995% by weight of water with respect to the total weight of the beverage,
optionally between 0,00002% and 0.05% by weight, preferably between 0,00005% and 0.02% by weight, and more preferably between 0,0001% and 0,005% by weight, of oat oil or oat oil fraction rich in polar lipid with respect to the total weight of beverage,
optionally between 0,00002% and 0.1% by weight, preferably between 0,00005% and 0.02% by weight, and more preferably between 0,0001% and 0,002% by weight, of monoglyceride or its derivatives with respect to the total weight of beverage,
optionally from 0% to 2% by weight, preferably from 0.01% to 1% by weight and more preferably from 0.01% to 0.5% by weight of acid such as citric acid with respect to the total weight of the beverage,
optionally from 0% to 15% by weight, preferably from 0.01% to 6,5% by weight and more preferably from 0.1% to 3,5% by weight of monosaccharide and/or disaccharide with respect to the total weight of the beverage.

Preferably, the beverage comprises dispersed oil droplets.

The average oil droplet size may be in the range comprised between 50 nm and 3 000 nm, preferably between 100 nm and 1 000 nm, more preferably between 150 nm and 500 nm, and even more preferably between 200 nm and 300 nm.

The average oil droplet size may have an impact on the stability of the beverage. In particular, high average oil droplet size, may require high shear during the mixing step, can lead to the agglomeration and creaming of the beverage and may trigger the vitamin D degradation.

Hydrocolloid and optionally monoglyceride or its derivatives may have an impact on the average oil droplet size.

By “average oil droplet size” it is preferably understood the average diameter of oil droplets, more preferably the average hydrodynamic diameter (Dh) as weighted by volume of the oil droplets.

The hydrodynamic diameter (Dh) of a molecule may be defined as the diameter of a perfect solid sphere that would exhibit the same hydrodynamic friction as the molecule of interest. Thus, the Dh value reflects primarily the hydrodynamic friction but is usually also a good estimation of the absolute size of the molecule especially in the case of oil droplets. Those are typically determined using light scattering experiments.

The average oil droplet size may be measured by any methods well-known for the skilled person.

Preferably, the average oil droplet size is measured by Static Light Scattering (SLS), Dynamic Light Scattering (DLS) or optical microscopy and more preferably by Dynamic Light Scattering (DLS).

The average oil droplet size and in particular the hydrodynamic diameter (Dh) of the oil droplets is a key parameter to analyze the aggregation phenomenon, which leads to unstable beverage.

Aggregation, coalescence, flocculation and creaming may characterize instability of a beverage.

The beverage stability may be determined by any well-known methods for the skilled person such as viscosity analysis, turbidity analysis, microscopy analysis, measurement of average oil particle size such as by Dynamic Light Scattering (DLS) and Zeta Potential Analysis.

Indicators of beverage instability may be:
a loss of turbidity,
agglomeration between droplets,
changes in the oil droplet size,
a decrease of zeta potential value,
changes in viscosity.

Preferably, according to the present invention the beverage is considered as being stable if:
the average oil droplet size is comprised between 50 nm and 3 000 nm, preferably between 100 nm and 1 000 nm, more preferably between 150 nm and 500 nm, and even more preferably between 200 nm and 300 nm, and
the loss of Vitamin D is weak.

Advantageously, the beverage as previously defined has a shelf life of at least 1 month, preferably of at least 6 months, more preferably of at least 12 months, more preferably of at least 18 months and even more preferably of at least 24 months.

By “shelf life” it is herein preferably understood the period during which the beverage retains acceptable physicochemical properties from a safety and organoleptic properties point of view.

The shelf life can be measured at a temperature ranging from 20 to 60° C. during a period from 2 weeks to 24 months. Preferably, extended shelf life is measured at 20 to 30° C. during 6 months to 24 months and accelerated shelf life is measured at 35 to 60° C. during 2 weeks to 6 months.

A second object of the present invention relates to a packaged beverage comprising the beverage as previously defined.

A third object of the present invention concerns a process for preparing a beverage comprising:
a step of mixing triglyceride and vitamin D or its derivatives, optionally monoglyceride or its derivatives, and optionally oat oil or oat oil fraction rich in polar lipid thereby providing a fat phase,
a step of dispersing the hydrocolloid in water, thereby providing an hydrocolloid dispersion, and
a step of mixing the fat phase and hydrocolloid dispersion, thereby providing a mixture of fat phase and hydrocolloid dispersion.

Preferably, the step of dispersing the hydrocolloid in water comprises the solubilization of the hydrocolloid in water.

The process may further comprise a step of diluting in water the mixture of fat phase and hydrocolloid dispersion, thereby providing a beverage.

The step of mixing the fat phase and hydrocolloid dispersion may be selected from dispersion, sonication such as ultrasonification, homogenization such as valve homogenization, high speed mixing, high shear mixing, mixing with rotor stator apparatus, mechanical agitation, extrusion, microfluidization, and combination thereof.

Preferably, the step of mixing the fat phase and hydrocolloid dispersion is performed using valve homogeneization with at least one step at a pressure comprised between 40 bars to 1 500 bars, preferably between 80 bars and 1 000 bars, and more preferably between 150 bars and 350 bars. The pressure used during the mixing step may have an impact on the average oil droplet size and thus on the beverage stability by decreasing the average oil droplet size. In particular, higher pressure is, the smaller the hydrodynamic diameter may be.

Advantageously, a pressure comprised between 40 bars to 1 500 bars enables to ensure a droplet size comprised between 50 nm and 3 000 nm, and thus to obtain a stable beverage. Below 40 bars, the average oil droplet size may be not sufficiently reduced. Above 1500 bars, the step of mixing may be not achievable at industrialization scale.

Preferably, the step of mixing the fat phase and hydrocolloid dispersion is a dispersion step and/or high shear mixing of fat phase in water followed by a homogenization step. The dispersion may be performed with a rotor/stator. The homogenization may be performed with a valve homogenizer.

An acid as previously defined may be added after the step of mixing the fat phase and hydrocolloid dispersion.

A monosaccharide, a disaccharide, or mixtures thereof, as previously defined may be added after the step of mixing the fat phase and hydrocolloid dispersion.

The step of mixing triglyceride and vitamin D or its derivatives and optionally monoglyceride or its derivatives and optionally oat oil or oat oil fraction rich in polar lipid and the step of mixing the fat phase and hydrocolloid dispersion may be performed at a temperature comprised between 20° C. and 110° C., preferably at a temperature comprised between 35° C. and 85° C. and more preferably at a temperature comprised between 50° C. and 70° C.

The process may further comprise at least one step of pasteurizing the mixture of fat phase and hydrocolloid dispersion.

By “at least one” it is herein preferably understood 1, 2, 3, 4 or 5, more preferably 1, 2, 3 or 4 steps, more preferably 1, 2 or 3, and even more preferably 1 or 2.

The pasteurization may allow decreasing the loss of vitamin D during shelf life.

By “pasteurizing” or “pasteurization” it is herein preferably understood a process in which the mixture of fat phase and hydrocolloid dispersion is heated at a temperature comprised between 60° C. and 130° C., preferably between 70° C. and 120° C., more preferably between 80° C. and 110° C., preferably for time comprised between 5 seconds and 30 min, more preferably between 10 seconds and 20 minutes, and even more preferably between 15 seconds and 5 minutes.

The process may also include a step of aseptic filing the beverage in a container.

A fourth object of the present invention relates to the use of the beverage as previously defined and of the packaged beverage comprising said beverage as previously defined, as a functional beverage.

By «functional beverage», it is herein preferably understood a non-alcoholic drinks providing health benefits beyond their nutritional value, positively affecting or functional focusing on the body or mind to promote the state of health and well-being. Preferably, the functional beverage is functional water.

The invention is further described with reference to the following examples. It will be appreciated that the invention as claimed is not intended to be limited in any way by these examples.

### EXAMPLES

### Example 1: Preparation of the Beverage

### 1. Material & Methods

a. Raw Material

TABLE 1
Characteristics of ingredients for preparing beverage

| | Commercial | Appear- | |
|---|---|---|---|
| Usual name | name/composition | ance | Supplier |
| Vitamin D | Vitamin D3 1.0 MIU/g | Oily | DSM (Basel |
| | | liquid | Switzerland) |
| Monoglyceride | Dimodan MO 90/D Kosher | Oily | Danisco |
| | Distilled mono-unsatured | solid | (Denmark) |
| | monoglyceride made from | | |
| | sunflower oil containing | | |
| | about 96 wt % | | |
| | monoglycerides | | |
| Triglyceride | Radiamuls MCT 2105K | Oily | Sofinol |
| | Medium Chain | liquid | (Switzerland) |
| | Triglyceride | | |
| | 60% C8:0 (caprylic acid), | | |
| | 40% C10:0 (capric acid) | | |
| Oat oil | Sweoat Oil PL40 FG | Oily | Swedish Oat |
| | | liquid | Fiber |
| Hydrocolloid | Eficacia XE Nexira | Powder | Nexira Food |
| | Natural product (100% | | (CNI Rouen, |
| | acacia gum) designed for | | France) |
| | emulsion applications. | | |
| | GMO free. | | |
| Citric acid | Citric acid anhydrous | Powder | Jungbunzlauer |
| | 100% | | (Germany) |
| Saccharide | Sucrose | Powder | — |

b. Commercial Beverage Used

Vittel Grande Source water commercialized by Nestlé.

### 2. Method

Sample 2 (listed in Table 2) has been prepared according to the following method.

Firstly, the aqueous phase was prepared by heating Vittel Grande Source water to 60° C. A magnetic stirrer was then used to disperse hydrocolloid (Eficacia XE Nexira-acacia gum) into water at 300 rpm thereby providing the aqueous phase. Secondly, the fat phase was prepared by mixing triglyceride (Radiamuls MCT 2105K) with monoglyceride (Dimodan MO 90/D Kosher), both heated to 60° C., until the complete dispersion of monoglyceride and obtaining of a homogeneous fat phase. Then, the vitamin D was added to the fat phase and the fat phase was kept at 60° C. The aqueous and fat phases were stirred by Polytron (rotor-stator system by Silverson Machines Ltd, England) at 6000 rpm for 2 minutes to form a coarse emulsion which was further homogenized using the high-pressure homogenizer Niro Pandaplus 2000 (GEA Mechanical Equipment, Italia) at 250±50 bars. At the end of the homogenization process, the acid citric was added to the emulsion to reach a pH of 3.5. Pasteurization is realized at 94° C. for 23 seconds in an oven with steam (GEA, SAP Italia) to ensure microbiological safety of emulsion. Diluted beverage were prepared by diluting the emulsion by a factor of 676 in water. Then, sucrose was added and citric acid was added to adjust the pH to 3.5. A second pasteurization was realized at 70° C. for 30 minutes. A concentration of 3 μg/L of vitamin D in the beverage was obtained. This concentration has been determined by the method LC-MS/MS (liquid chromatography coupled to tandem mass spectrometry).

The other beverage formulations listed in Table 2 have been prepared according to the same method. Regarding sample 4, oat oil is added with triglycerides. The percentages are percentages by weight with respect to the total weight of the beverage.

TABLE 2
Different formulations of beverage

| | | | Hydro- | Mono- | | | Citric | |
|---|---|---|---|---|---|---|---|---|
| | Vitamin D | Triglyceride | colloid | glyceride | Oat oil | Saccharide | acid | Water |
| | (% by | (% by | (% by | (% by | (% by | (% by | (% by | (% by |
| Sample | weight) | weight) | weight) | weight) | weight) | weight) | weight) | weight) |
| 1 | 0.0000003 | 0.00072 | 0.0043 | — | — | 3 | 0.1 | 96.89498 |
| 2 | 0.0000003 | 0.00043 | 0.0043 | 0.0003 | — | 3 | 0.1 | 96.89497 |
| 3 | 0.0000003 | 0.000089 | 0.0043 | 0.000059 | — | 3 | 0.1 | 96.895552 |
| 4 | 0.0000003 | 0.00055 | 0.0043 | — | 0.00018 | 3 | 0.1 | 96.89497 |

### 3. Physical Stability Analysis

### Particle Size (Average Oil Droplet Size)

Particle size was measured in the emulsion using Dynamic light scattering instrument with a NanoLab 3D (LS Instruments, Fribourg, Switzerland). All measurements were performed at 20° C. and in triplicates at a scattering angle of 90° and viscosity was determined using a rotational test with a conical geometry and the Physica MCR 501 rheometer from Anton Paar was used (Graz, Austria).

### Viscosity Analysis

Viscosity measurements were performed at 20° C. with the Physica MCR 501 rheometer from Anton Paar. A conical geometry was used and 20 mL of each sample were introduced into the receptacle. Viscosity measurements of the different water phases used to produce emulsions were mandatory for DLS analysis. Indeed, the solvent's viscosity is required (as the RI-Refractive Index) to measure the size distribution of droplets (the hydrodynamic diameter depends on the solvent's viscosity and RI). Moreover, viscosity analysis confirms the Newtonian behavior of emulsions.

### Dynamic Light Scattering

Dynamic light scattering (DLS) technique is used for rapidly determining the size distribution of small particles or droplets in suspensions in the range from 0.15 nm to 5 μm with NanoLab 3D (LS Instruments, 2020). Due to Brownian motion of small particles, the change of relative spatial location will induce the intensity fluctuation. DLS is based on recording intensity fluctuations when light is scattered by particles. The statistics of these fluctuations are reflected in the correlation function. DLS can extract the particle size distribution from the obtained correlation function. The NanoLab 3D is patented Modulated 3D Cross-Correlation technology and it allows the suppression of the influence of multiple scattering in the signal due to turbid samples. Sample dilution is no longer required with this instrument. All measurements were performed at 20° C. and in triplicates at a scattering angle of 90°.

### 4. Quantification of Vitamin D3

### Determination of Concentration of Vitamin D3

TABLE 3
UV parameters for spectrophotometric
determination of concentration

| | Λmax | | Aliquot | | Dilution |
|---|---|---|---|---|---|
| Compound | [nm] | E_{1 cm}^{1%} | [μL] | Solvent | factor |
| Cholecalciferol | 265 | 480 | 200 | EtOH | 50 |

The absorbance was measured (Δ_{λmax}) at the maximum absorbance wavelength (λₘₐₓ) and according to the following formula the concentration was determined.

$$Concentration ( µg / mL ) = \frac{ABSstd \times D \times 1000}{E 1 cm 1 \%}$$

ABS_{std}=Absorbance measured at λmax [nm]
E_{1 cm}^{1%}=Mass extinction coefficient (theorical absorbance of a 1% solution)
D=Dilution factor (volume of aliquot/final volume)
10000=Conversion factor to express the final result in μg/ml

Sample's preparation was done by saponification and liquid-liquid extraction. 200 μL of standard is added before saponification and the residue after evaporation is resolved in 2 mL of hexane. The method applied is Liquid Chromatography (LC) with detection by spectrophotometry, it is commonly used in the analysis of fat-soluble vitamins.

The uncertainty associated with the measurement method is approximately equal to +9%.

### 5. Results

Results of the stability of the beverage are presented in tables 4 to 6 below.

TABLE 4
Average oil droplet size for the different samples.
Values represent the average hydrodynamic diameter
using “Corenn” volume calculation in the software
of the NanoLab 3D (LS Instruments, Fribourg, Switzerland).

| | Lipid content | |
|---|---|---|
| | (Triglyceride and | Average oil |
| | optionally | droplet size |
| | monoglyceride or | (nanometer) |
| | optionally oat oil) | measured in |
| Sample | (% by weight) | the emulsion |
| 1 | 0.00072% | 290 nm |
| 2 | 0.00073% | 290 nm |
| 3 | 0.000148% | 225 nm |
| 4 | 0.00073% | — |

TABLE 5
Accelerated shelf life (40° C., light):
loss of Vitamin D (%) for samples 1 to 4

| Sample | T0 | 5 days | 11 days |
|---|---|---|---|
| 1 | 0 | 52 | 63 |
| 2 | 0 | 24 | 52 |
| 3 | 0 | 38 | 80 |
| 4 | 0 | — | 42 |

TABLE 6
Extended shelf life (20° C., light) for sample 2

| | | 2 | 4 | 6 | 8 |
|---|---|---|---|---|---|
| Time | T0 | months | months | months | months |
| Loss of | 0 | 21 | 23 | 31 | 31 |
| Vitamin | | | | | |
| D (%) | | | | | |

### CONCLUSION

The results for samples 1, 2, 3 and 4, which contain vitamin D, a triglyceride, a hydrocolloid and optionally a monoglyceride or optionally oat oil and with a lipid content (triglyceride and optionally monoglyceride or oat oil) within the claimed range show a good stability. 5

The lipid content has thus an impact on the beverage stability. In particular, the lipid content within the claimed range enables to prevent vitamin D from chemical degradation (less vitamin D loss) and to obtain a particle size (diameter) comprised between 200 nm and 300 nm thereby avoiding the aggregation phenomenon and thus providing a stable emulsion and thus a stable 10 beverage.

1. A beverage comprising:
between 1.10⁻⁷% and 8.10⁻⁵% by weight of vitamin D or its derivatives with respect to the total weight of beverage,
between 0,0005% and 1,2% by weight of hydrocolloid with respect to the total weight of beverage, and
between 0,000003% and 0.2% by weight of triglyceride with respect to the total weight of beverage.

2. The beverage according to claim 1, wherein the triglyceride is a medium chain triglyceride.

3. The beverage according to claim 1, wherein the hydrocolloid is selected from the group consisting of polysaccharides such as including acacia gum, xanthan gum, gelatin, carrageenan gum, gellan gum, karaya gum, larch gum, dextran, chitosan, alginate, hyaluronic acid, guar gum, pectin, cellulose, tara gum, tamarind gum, ghatti gum, curdlan gum, konjac glucomannan, scleroglucan, pullulan, agar, tragacanth gum, Portulaca oleracea gum, galactomannan, pectin, starch or modified starch, cellulose derivative.

4. The beverage according to claim 1, further comprising monoglyceride or its derivatives.

5. The beverage according to claim 4, wherein the monoglyceride is an unsaturated monoglyceride.

6. The beverage according to claim 1, wherein said beverage comprises between 0,00002% and 0.1% by weight of monoglyceride or its derivatives with respect to the total weight of beverage.

7. The beverage according to claim 1, wherein the ratio between the total amount of hydrocolloid and the total amount of vitamin D or its derivatives in the beverage (hydrocolloid/vitamin D) is between 5 and 1 000 000.

8. The beverage according to claim 1, wherein the ratio between the total amount of triglyceride and the total amount of vitamin D or its derivatives in the beverage between 150 and 100 000.

9. The beverage according to claim 1, wherein the ratio between the total amount of triglyceride and the total amount of vitamin D or its derivatives in the beverage is between 150 and 100 000.

10. The beverage according to claim 1, wherein the ratio between the total amount of hydrocolloid and the total amount of triglyceride is between 1 and 100.

11. The beverage according to claim 1, wherein the ratio between the total amount of triglyceride and the total amount of monoglyceride or its derivatives in the beverage is comprised between 0, 5 and 100.

12. The beverage according to claim 1, wherein the beverage comprises dispersed oil droplets having an average oil droplet size in the range between 50 nm and 3 000 nm.

13. (canceled)

14. A process for preparing a beverage comprising:
a step of mixing triglyceride and vitamin D or its derivatives, thereby providing a fat phase,
a step of dispersing the hydrocolloid in water, thereby providing an hydrocolloid dispersion, and
a step of mixing the fat phase and hydrocolloid dispersion, thereby providing a mixture of fat phase and hydrocolloid dispersion.

15. (canceled)
